(19) United States
(12) Patent Application Publication
(10) Pub. No.: US 2020/0184299 A1
(43) Pub. Date: Jun. 11, 2020

(54) CARD-MAKING SUBSTRATE AND PREPARATION METHOD THEREOF AND IC CARD OR ELECTRONIC TAG CONTAINING THE SAME

(71) Applicant: Tianjin Boyuan New Materials Co., Ltd, Tianjin (CN)

(72) Inventors: Yi WANG, Tianjin (CN); He SONG, Tianjin (CN); Yajun CAO, Tianjin (CN); Fei TENG, Tianjin (CN); Wei LI, Tianjin (CN)

(21) Appl. No.: 16/706,962

(22) Filed: Dec. 9, 2019

(30) Foreign Application Priority Data
Dec. 10, 2018 (CN) 201811503836.8

(51) Int. Cl. G06K 19/077; B32B 15/09; B32B 27/36; B32B 15/20; B32B 7/12; B23K 26/362

(52) U.S. Cl. CPC G06K 19/0772; B32B 15/09; B32B 27/36; B32B 2425/00; B32B 7/12; B23K 26/362; B32B 15/20

(57) ABSTRACT

Provided is a card-making substrate, a preparation method thereof and an IC card or electronic tag containing the same. The card-making substrate comprises an aluminum laminated film layer, a bonding adhesive layer and a base material layer that are stacked in sequence. At least one continuous scratch is formed on a surface of the aluminum laminated film layer. The scratch has a depth greater than the thickness of the aluminum film in the aluminum laminated film layer. The aluminum film in the aluminum laminated film layer is divided into at least two regions that are not connected with each other by the scratch and the edge of the aluminum laminated film layer. According to the present invention, at least one continuous scratch is simply added on the surface of the aluminum laminated film layer in a common card-making substrate, and the aluminum film therein is divided into at least 2 regions which are not connected with each other, which allows the contactless IC card or electronic tag made using the card-making substrate to have a longer read and write distance without damaging the appearance effect of the aluminum laminated film having a laser effect.

### TECHNICAL FIELD

The present invention belongs to the technical field of IC card manufacturing, and particularly relates to a card-making substrate, a preparation method thereof and an IC card or electronic tag containing the same.

### BACKGROUND

In recent years, novel card-making materials with distinct individual features represented by a laser card-making substrate are widely concerned by relevant enterprises in the world. The laser card-making substrate is a card-making material with laser appearance effect obtained by compounding a laser aluminum laminated film and a plastic (generally a PVC material) sheet material, and this card-making material can be combined with other card-making materials through a laminating or thermal compounding process for use in the manufacture of financial cards, high-end VIP cards and various intelligent cards. However, the aforementioned card-making material usually contains a metal layer. Thus, when it is applied to the fields of contactless cards such as IC cards, the metal layer generates a metal shielding effect, resulting in problems such as reducing read and write distance of the contactless cards.

At present, there is not a better solution for the problem of reduced read and write distance of the contactless cards caused by the presence of the metal layer. One idea is to increase the read and write distance of an IC card by improving the design of the IC card chip and its radio frequency communication circuit. For instance, CN 2898956Y discloses a circuit structure capable of improving the operating distance of a contactless IC card, wherein the circuit is designed to connect an antenna coil with one capacitor in parallel outside the integrated circuit chip to increase the read and write distance of the contactless card by reducing the resistance loss in the circuit communication process through reducing the number of turns of the coil and increasing capacitance. The above scheme would increase the production cost of the IC card chip and the assembly cost of the IC card.

Another idea is to increase the read and write distance of a contactless card by improving the composition or structure of the card-making material of the contactless card. For example, CN107529649A discloses a contactless IC card with a holographic laser film attached, which comprises an IC card chip and a card structure in which the IC card chip is arranged, wherein the card structure comprises an upper side card structure and a lower side card structure, the upper side card structure comprising a series of holographic PET/PVC laser plastic layers, a printing layer, a PET/PVC film layer and the like which are arranged on the IC chip from inside to outside in sequence; said series of holographic PET/PVC laser plastic layers comprises a PET/PVC plastic layer, a glue layer, a combination layer, a metal plated layer/nano new material layer, a PET/PVC base film layer and the like which are arranged from inside to outside in sequence; and a holographic laser pattern is formed on the metal plated layer/nano new material layer. By replacing the common aluminum laminated film having a thickness of 380±50 angstroms with the metal plated layer/the nano new material layer having a thickness of 150±50 angstroms, the read and write distance of the obtained contactless IC card can be increased to a certain extent with an increasing rate of about 10-20%. Although this method has the effect of increasing the read and write distance of the contactless card to a certain extent, the apparent brightness of the obtained IC card will be greatly reduced, which violates the original intention of providing personalized modification effect by applying laser aluminum laminated film to the technical field of IC card manufacturing, and the practical application effect is poor.

Hence, on the basis of the prior art, those skilled in the art need to find a laser card-making substrate capable of increasing the read and write distance of a contactless card containing the laser card-making substrate on the premise of not damaging the appearance effect of the laser aluminum laminated film.

### SUMMARY

In view of the deficiencies existing in the existing technologies, the present invention aims to provide a card-making substrate capable of increasing the read and write distance of a contactless card containing the laser card-making substrate on the premise of not damaging the appearance effect of the laser aluminum laminated film, a preparation method thereof and a contactless IC card (Integrated Circuit Card) or electronic tag containing the same.

One of the purposes of the present invention is to provide a card-making substrate, which comprises an aluminum laminated film layer, a bonding adhesive layer and a base material layer that are stacked in sequence.

The card-making substrate is used for fixing an IC card chip and a matching radio frequency communication circuit for producing a contactless IC card or electronic tag.

Preferably, the card-making substrate contains an aluminum laminated film layer which enables the card-making substrate to have a laser effect.

There is at least one continuous scratch on the aluminum film surface of aluminum laminated film layer. Continuous scratch means that the scratch is a curve or a straight line that does not repeat arbitrary point on the route. For example, two straight lines that intersect in the cross shape belong to the pattern that is formed by two continuous scratches.

The scratch has a depth greater than the thickness of the aluminum film in the aluminum laminated film layer. The aluminum film in the aluminum laminated film layer is divided into at least two regions that are not connected with each other by the scratch and the edge of the aluminum laminated film layer, wherein the expression “not connected with each other” means being not connected with each other in topological structure.

According to the present invention, by dividing the aluminum film in the aluminum laminated film layer of the card-making substrate into a plurality of regions that are not connected with each other, the induced current formed on the surface of the aluminum film due to the electromagnetic eddy current effect can be reduced, and the intensity of an electromagnetic signal received by a radio frequency communication circuit in a contactless IC card or electronic tag containing the same is improved. As the laser effect on the surface of the card-making substrate is generally shown by the aluminum film in the aluminum laminated film layer, the present invention can realize the improvement of the read and write distance of a contactless IC card or electronic tag containing the card-making substrate on the premise of not damaging the laser effect on the surface of the laser card-making substrate and not reducing the surface glossiness of the card-making substrate having laser effect.

A card-making substrate that has a continuous scratch on the surface of the aluminum film in the aluminum laminated film layer but has no laser effect is also within the scope of protection of the present invention, but the effect of improving the read and write distance of the contactless IC card or electronic tag containing the same is slightly worse than that obtained by directly removing the aluminum film from the aluminum laminated film layer.

Preferably, the area ratio of any two aluminum film regions in the aluminum laminated film layer is 0.01-100:1, e.g. 0.02:1, 0.05:1, 0.1:1, 0.2:1, 0.4:1, 0.6:1, 0.8:1, 1:1, 1.2:1, 1.5:1, 2:1, 2.5:1, 4:1, 5:1, 7:1, 8:1, 9:1, 10:1, 12:1, 15:1, 20:1, 25:1, 40:1, 50:1, 60:1, 70:1, 80:1, 90:1 or 95:1, and the like. The reduction of the electromagnetic eddy current effect due to an excessively large area difference between the regions can be prevented by reducing the area ratio of any two aluminum film regions, and therefore, the ratio is further preferably 0.1-10:1.

Preferably, the aluminum film in the aluminum laminated film layer is divided into 6-20 (e.g. 7, 8, 9, 10, 11, 12, 13, 14, 15, 16, 17, 18 or 19, and the like) regions that are not connected with each other by the scratch and the edge of the aluminum laminated film layer.

Preferably, the aluminum film in the aluminum laminated film layer is divided into 6-20 triangular, quadrangular or pentagonal regions that are not connected with each other by the scratch and the edge of the aluminum laminated film layer.

Preferably, the aluminum film in the aluminum-plated film layer is divided into 6-20 triangular, rectangular, square or rhombus regions that are not connected with each other by the scratch and the edge of the aluminum laminated film layer.

The above selections of the number and shape of the regions can further improve the read and write distance of the contactless IC card or electronic tag containing the card-making substrate according to the present invention. The increase of the number of the regions can further improve the read and write distance. However, when there are too many regions, the improvement effect is limited and the laser effect on the surface of the card-making substrate would be damaged. When the shapes of the regions have more sharp edges, the read and write distance can be further improved.

Preferably, the length of the minimum side of the triangular, rectangular, square or rhombus region is ≥1 mm, e.g. 1.5 mm, 2 mm, 2.5 mm, 3 mm, 3.5 mm, 5 mm, 7 mm, 10 mm, 12 mm, 15 mm or 20 mm, and the like.

The present invention can be realized by selecting scratch with any width and depth according to practical situations by those skilled in the art for the purpose of protecting the laser effect and the glossiness of the surface of the card-making substrate.

Preferably, the scratch has a width of 0.001-10 mm, e.g. 0.005 mm, 0.01 mm, 0.02 mm, 0.05 mm, 0.08 mm, 0.1 mm, 0.15 mm, 0.2 mm, 0.4 mm, 0.6 mm, 0.8 mm, 1 mm, 1.5 mm, 2 mm, 2.5 mm, 3 mm, 3.5 mm, 4 mm, 4.5 mm, 5 mm, 5.5 mm, 6 mm, 7 mm, 8 mm or 9 mm, and the like, further preferably 0.01-1 mm.

Preferably, the depth of the scratch is 101-4000%, e.g. 105%, 110%, 120%, 135%, 150%, 165%, 180%, 200%, 300%, 400%, 600%, 800%, 1000%, 1400%, 1800%, 2300%, 2800%, 3200%, 3500%, 3600%, 3700%, 3800%, 3900% or 3950% and the like, further preferably 101-200% of the thickness of the aluminum film in the aluminum laminated film layer.

Preferably, the scratch on the surface of the aluminum laminated film layer is obtained by performing laser etching, chemical etching or mechanical cutting on the aluminum laminated film layer.

Preferably, the aluminum laminated film layer includes a polymer film laminated with an aluminum film on single side.

Preferably, the polymer film has a thickness of 0.005-1 mm, e.g. 0.008 mm, 0.01 mm, 0.015 mm, 0.02 mm, 0.03 mm, 0.05 mm, 0.07 mm, 0.1 mm, 0.2 mm, 0.3 mm, 0.4 mm, 0.5 mm, 0.6 mm, 0.7 mm, 0.8 mm, 0.9 mm, and the like, further preferably 0.01-0.08 mm.

Preferably, the polymer film is a polyethylene terephthalate (PET) film.

Preferably, the thickness of the aluminum film in the aluminum laminated film layer is 10-50 nm, e.g. 12 nm, 15 nm, 18 nm, 22 nm, 26 nm, 30 nm, 33 nm, 36 nm, 39 nm, 42 nm, 45 nm or 48 nm, and the like.

Preferably, the bonding adhesive layer has a thickness of 1-50 μm, e.g. 2 μm, 4 μm, 6 μm, 10 μm, 15 μm, 20 μm, 25 μm, 30 μm, 35 μm, 40 μm, 45 μm or 48 μm, and the like.

Preferably, the base material layer has a thickness of 0.1-0.5 mm, e.g. 0.15 mm, 0.2 mm, 0.25 mm, 0.3 mm, 0.35 mm, 0.4 mm, 0.45 mm or 0.48 mm, and the like.

Preferably, the base material layer comprises a base material and a backing adhesive coated on the upper and lower surfaces of the base material.

Preferably, the base material is any one selected from the group consisting of polyvinyl chloride (PVC), acrylonitrile-butadiene-styrene copolymer (ABS), polycarbonate (PC), polyethylene terephthalate (PET), polycondensation copolymer of terephthalic acid, ethylene glycol and 1,4-cyclohexanedimethanol (PETG), and polystyrene (PS) resin, or a mixture of at least two selected therefrom.

Preferably, the backing adhesive is any one selected from the group consisting of an aqueous polyurethane adhesive, an aqueous epoxy adhesive, an aqueous polyacrylate adhesive and an aqueous bismaleimide adhesive, or a mixture of at least two selected therefrom.

The second object of the present invention is to provide a preparation method of the card-making substrate, comprising the following steps:

Step (1), the aluminum laminated film is coated with a bonding adhesive on the side containing an aluminum film; after the bonding adhesive becomes dried, the side of the aluminum laminated film containing the bonding adhesive is laminated with a substrate layer, followed by cutting to obtain a pretreated substrate;

Step (2), laser etching treatment is performed on the surface of the aluminum laminated film layer in the pretreated substrate obtained in Step (1) so as to form continuous scratch(es) on the surface of the aluminum film, so that a card-making substrate is obtained.

Preferably, the base material layer in Step (1) is obtained by roll-coating a backing adhesive on each of the upper and lower surfaces of the base material, followed by drying and cutting.

Preferably, the surface of the aluminum laminated film in Step (1) has a laser effect.

The third object of the present invention is to provide a further preparation method of the card-making substrate, comprising the following steps:

Step (a), laser engraving, chemical etching or mechanical cutting treatment is performed on the surface of the aluminum laminated film containing an aluminum film so as to form continuous scratch(es) on the surface of the aluminum film, so that an aluminum laminated film with scratch(es) on the surface is obtained;

Step (b), the aluminum film in the aluminum laminated film with scratch(es) on the surface is coated with a layer of bonding adhesive; after the adhesive becomes dried, the side of the aluminum laminated film containing the bonding adhesive is laminated with a base material layer, thus the card-making substrate is obtained.

Preferably, the base material layer in Step (a) is obtained by roll-coating a back adhesive on each of the upper and lower surfaces of the base material, followed by drying and cutting.

Preferably, the surface of the aluminum laminated film in Step (a) has a laser effect.

The fourth object of the present invention is to provide a contactless IC card or electronic tag, comprising one piece of the card-making substrate and an IC chip and a radio frequency communication circuit which are fixed in the base material layer of the card-making substrate.

The fifth object of the present invention is to provide another contactless IC card or electronic tag, comprising the card-making substrate having two substrate layers attached to each other, and an IC chip and a radio frequency communication circuit which are fixed in any of the base material layers of the card-making substrate.

Numerical ranges recited herein include not only the recited numerical values, but also any numerical values therebetween which are not recited. The specific point values included in said ranges are not exhaustively illustrated by the present invention due to space limitations and for the sake of conciseness.

As compared to the existing technologies, the present invention has the following beneficial effects:

according to the present invention, at least one continuous scratch is simply added on the surface of the aluminum film in the aluminum laminated film layer on the surface of a common card-making substrate, and thus the aluminum film is divided into at least two regions which are not connected with each other, which allows the contactless IC card (or electronic tag) made using the card-making substrate to have a longer read and write distance without damaging the appearance effect of a laser aluminum laminated film.

### BRIEF DESCRIPTION OF THE DRAWINGS

FIG. 1 is a schematic structural view of a laser card-making substrate 1 obtained in Example 1 in the specific embodiments of the present invention, in which 001 is an aluminum laminated film layer, 002 is a bonding adhesive layer, and 003 is a base material layer.

FIG. 2 shows a pattern formed by scratches on the surface of an aluminum film in aluminum laminated film layer of a laser card-making substrate 1 obtained in Example 1 in the specific embodiments of the present invention.

FIG. 3 shows a pattern formed by scratches on the surface of an aluminum film in aluminum laminated film layer of a laser card-making substrate 2 obtained in Example 2 in the specific embodiments of the present invention.

FIG. 4 shows a pattern formed by scratches on the surface of an aluminum film in aluminum laminated film layer of a laser card-making substrate 3 obtained in Example 3 in the specific embodiments of the present invention.

FIG. 5 shows a pattern formed by scratches on the surface of an aluminum film in aluminum laminated film layer of a laser card-making substrate 4 obtained in Example 4 in the specific embodiments of the present invention.

FIG. 6 shows a pattern formed by scratches on the surface of an aluminum film in aluminum laminated film layer of a laser card-making substrate 5 obtained in Example 5 in the specific embodiments of the present invention.

FIG. 7 shows a pattern formed by scratches on the surface of an aluminum film in aluminum laminated film layer of a laser card-making substrate 6 obtained in Example 6 in the specific embodiments of the present invention.

FIG. 8 shows a pattern formed by scratches on the surface of an aluminum film in aluminum laminated film layer of a laser card-making substrate 7 obtained in Example 7 in the specific embodiments of the present invention.

FIG. 9 shows a pattern formed by scratches on the surface of an aluminum film in aluminum laminated film layer of a laser card-making substrate 8 obtained in Example 8 in the specific embodiments of the present invention.

### DETAILED DESCRIPTION

The technical solution of the present invention is further explained by the following specific embodiments.

### Example 1

A laser card-making substrate 1 was prepared by the following steps:

Step (1), the aluminum laminated film was coated with a layer of bonding adhesive with a thickness of 30 μm on the side containing an aluminum film; after the adhesive became dried, the side of the aluminum laminated film containing the bonding adhesive was laminated with a base material layer 003 with a thickness of 0.5 mm, followed by cutting to obtain a pretreated substrate;

Step (2), laser etching treatment was performed on the surface of the aluminum laminated film layer in the pretreated substrate obtained in Step (1) so as to form continuous scratches on the surface of the aluminum film, wherein the scratches had a width of 0.05 mm and a depth of 55 nm, and the aluminum film of the aluminum laminated film was divided by the scratches into 20 square regions with the side length of 1 mm that were not connected with each other, so that a laser card-making substrate was obtained.

Wherein, the aluminum laminated film in the Step (1) was a PET film laminated with an aluminum film on a surface thereof; the thickness of the PET film was 0.08 mm, and the thickness of the aluminum film was 35 nm.

The base material layer 003 in Step (1) was obtained by roll-coating a layer of an aqueous epoxy resin adhesive on each of the upper and lower surfaces of a PVC resin sheet, followed by drying and cutting.

The surface of the aluminum laminated film in Step (1) had a laser effect.

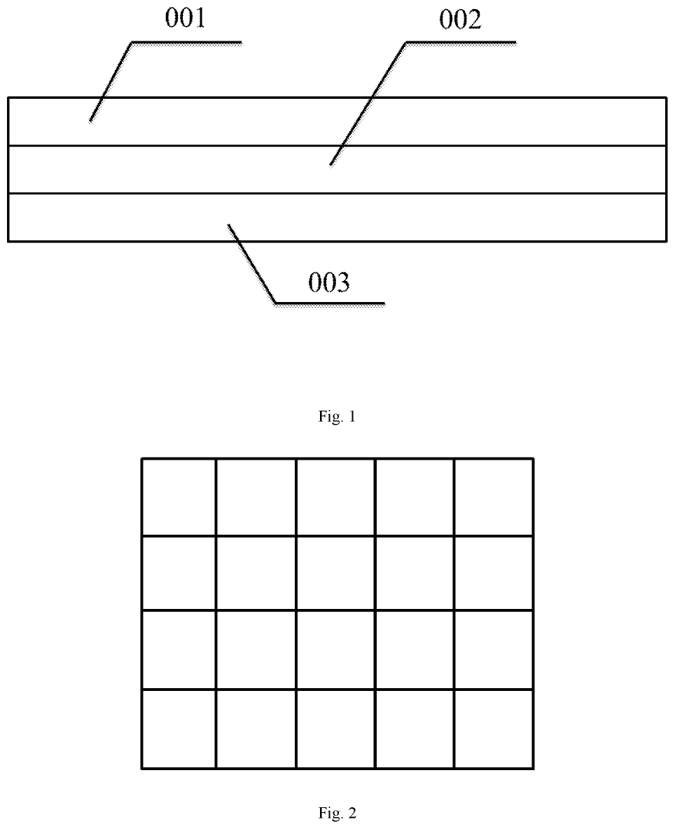

A schematic structural view of the laser card-making substrate 1 obtained in Example 1 is shown in FIG. 1. Said laser card-making substrate consists of aluminum laminated film layer 001, bonding adhesive layer 002 and base material layer 003 that are stacked in sequence.

Scratches allow the surface of the aluminum film in the aluminum laminated film layer of the laser card-making substrate 1 obtained in Example 1 to have a pattern as shown in FIG. 2.

### Example 2

A laser card-making substrate 2 was prepared by the same steps as Example 1 except that the aluminum film of the aluminum laminated film was divided by scratches into 12 square regions with the side length of 1.29 mm that were not connected with each other.

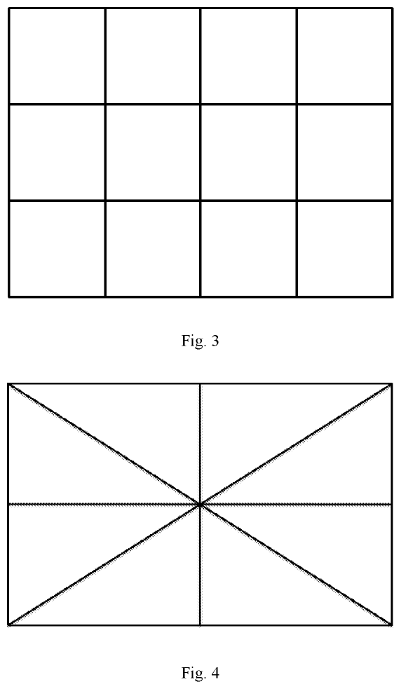

Scratches allow the surface of the aluminum film in the aluminum laminated film layer of the laser card-making substrate 2 obtained in Example 2 to have a pattern as shown in FIG. 3.

### Example 3

A laser card-making substrate 3 was prepared by the same steps as Example 1 except that the aluminum film of the aluminum laminated film was divided by scratches into 8 right-angled triangular regions having side lengths of 2 mm, 2.5 mm and 3.2 mm respectively that were not connected with each other.

Scratches allow the surface of the aluminum film in the aluminum laminated film layer of the laser card-making substrate 3 obtained in Example 3 to have a pattern as shown in FIG. 4.

### Example 4

A laser card-making substrate 4 was prepared by the same steps as Example 1 except that the aluminum film of the aluminum laminated film was divided by scratches into 4 rectangular regions each being 1 mm wide and 5 mm long that were not connected with each other.

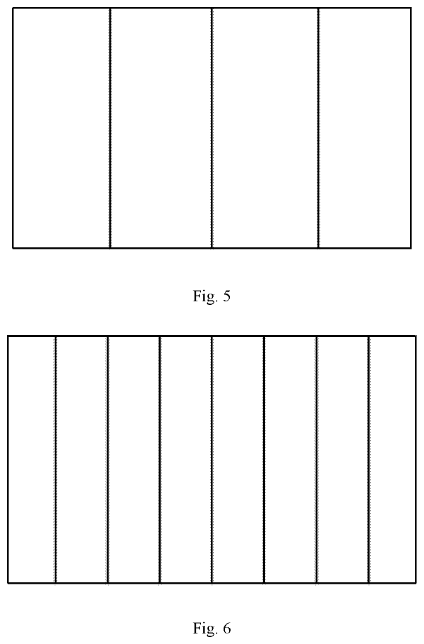

Scratches allow the surface of the aluminum film in the aluminum laminated film layer of the laser card-making substrate 4 obtained in Example 4 to have a pattern as shown in FIG. 5.

### Example 5

A laser card-making substrate 5 was prepared by the same steps as Example 1 except that the aluminum film of the aluminum laminated film was divided by scratches into 8 rectangular regions each being 0.5 mm wide and 5 mm long that were not connected with each other.

Scratches allow the surface of the aluminum film in the aluminum laminated film layer of the laser card-making substrate 5 obtained in Example 5 to have a pattern as shown in FIG. 6.

### Example 6

A laser card-making substrate 6 was prepared by the same steps as Example 1 except that the aluminum film of the aluminum laminated film was divided by scratches into 2 regions that were not connected with each other, wherein one region was an ellipse positioned in the center of the aluminum film of the aluminum laminated film, the other region was arranged around the ellipse, and the area ratio of the two regions was 10:1.

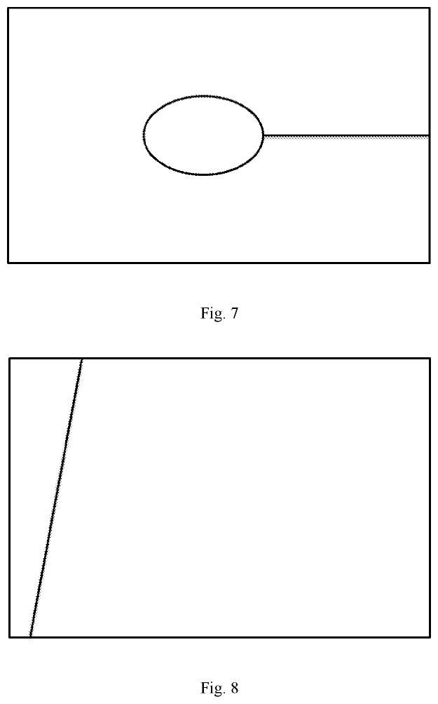

Scratches allow the surface of the aluminum film in the aluminum laminated film layer of the laser card-making substrate 6 obtained in Example 6 to have a pattern as shown in FIG. 7.

### Example 7

A laser card-making substrate 7 was prepared by the same steps as Example 1 except that the aluminum film of the aluminum laminated film was divided by a scratch into 2 trapezoidal regions that were not connected with each other, wherein the area ratio of the two regions was 20:1.

The scratch allows the surface of the aluminum film in the aluminum laminated film layer of the laser card-making substrate 7 obtained in Example 7 to have a pattern as shown in FIG. 8.

### Example 8

A laser card-making substrate 8 was prepared by the same steps as Example 1 except that the aluminum film of the aluminum laminated film was divided by a scratch into one trapezoidal region and one triangular region that were not connected with each other, wherein the area ratio of the two regions was 100:1.

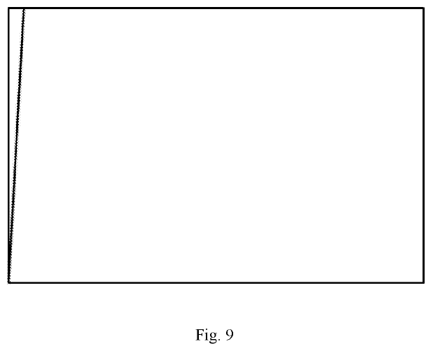

The scratch allows the surface of the aluminum film in the aluminum laminated film layer of the laser card-making substrate 8 obtained in Example 8 to have a pattern as shown in FIG. 9.

### Example 9

A laser card-making substrate 9 was prepared by the same steps as Example 1 except that the depth of the scratches in Step (2) was 100 nm, and the aluminum laminated film in Step (1) was a PET film laminated with an aluminum film on a surface thereof, wherein the thickness of the PET film was 0.01 mm, and the thickness of the aluminum film was 50 nm.

### Example 10

A laser card-making substrate 10 was prepared by the following steps:

Step (a), mechanical cutting treatment was performed on the surface of the aluminum laminated film containing an aluminum film so as to form continuous scratches on the surface of the aluminum film, wherein the scratches had a width of 1 mm and a depth of 1 μm, and the aluminum film of the aluminum laminated film was divided by the scratches into 20 square regions with the side length of 1 mm that were not connected with each other, so that an aluminum laminated film with scratches on a surface thereof was obtained;

Step (b), the aluminum film in the aluminum laminated film with scratches on the surface was coated with a layer of bonding adhesive with a thickness of 30 μm on the surface thereof; after the adhesive became dried, the side of the aluminum laminated film containing the bonding adhesive was laminated with a base material layer 003 with a thickness of 0.5 mm, and thus the laser card-making substrate 10 was obtained.

Wherein the aluminum laminated film in Step (a) was a PET film laminated with an aluminum film on a surface thereof; the thickness of the PET film was 0.3 mm, and the thickness of the aluminum film was 35 nm.

The base material layer 003 in Step (b) was obtained by roll-coating a layer of an aqueous epoxy resin adhesive on each of the upper and lower surfaces of a PVC resin sheet, followed by drying and cutting.

The surface of the aluminum laminated film in Step (a) had a laser effect.

### Comparative Example 1

A laser card-making substrate 11 was prepared by the following steps:

the aluminum film in the aluminum laminated film was coated with a layer of bonding adhesive with a thickness of 30 μm on the surface thereof; after the adhesive became dried, the side of the aluminum laminated film containing the bonding adhesive was laminated with a substrate layer with a thickness of 0.5 mm, and thus the laser card-making substrate 11 was obtained.

Wherein the aluminum laminated film was a PET film laminated with an aluminum film on a surface thereof; the thickness of the PET film was 0.08 mm, and the thickness of the aluminum film was 35 nm. The substrate layer was obtained by roll-coating a layer of an aqueous epoxy resin adhesive on each of the upper and lower surfaces of a PVC resin sheet, followed by drying and cutting.

### Comparative Example 2

A laser card-making substrate 12 was prepared by the following steps:

a PET film with a thickness of 0.08 mm was coated with a layer of bonding adhesive with a thickness of 30 μm on a surface thereof; after the adhesive became dried, the side of the aluminum laminated film containing the bonding adhesive was laminated with a substrate layer with a thickness of 0.5 mm, and thus the laser card-making substrate 12 was obtained.

The substrate layer was obtained by roll-coating a layer of an aqueous epoxy resin adhesive on each of the upper and lower surfaces of a PVC resin sheet, followed by drying and cutting.

The Inlay-type IC chip produced by Samgtron company and the matching radio frequency communication circuit were respectively fixed in the base material layers of the laser card-making substrates 1-12 obtained in the above examples and comparative examples, thus contactless IC cards 1-12 were obtained.

The Inlay-type IC chip produced by Samgtron company and the matching radio frequency communication circuit were respectively fixed in the base material layers of the laser card-making substrates 1-12 obtained in the above examples and the comparative examples, and then the base material layers of the laser card-making substrates 1-12 with the IC chips fixed therein were respectively attached to the base material layers of the same kind of laser card-making substrates, thus contactless IC cards 13-24 were obtained.

From the visual inspection of the laser effect and the glossiness of the surfaces of the obtained contactless IC cards, it was found that the obtained contactless IC cards 1-24 had similar glossiness, and the laser effect of the surfaces was not destroyed.

The read and write distances of the obtained contactless IC cards 1-24 were measured respectively, with the test frequency of a reader-writer being 13.56 MHz, and the results were shown in Table 1.

TABLE 1
Read and write distances of contactless IC cards 1-24

| Contactless IC card | 1 | 2 | 3 | 4 | 5 | 6 | 7 | 8 | 9 | 10 | 11 | 12 |
|---|---|---|---|---|---|---|---|---|---|---|---|---|
| Read and write distance (mm) | 43 | 43 | 43 | 41 | 40 | 40 | 40 | 38 | 43 | 42 | 34 | 45 |
| Contactless IC card | 13 | 14 | 15 | 16 | 17 | 18 | 19 | 20 | 21 | 22 | 23 | 24 |
| Read and write distance (mm) | 36 | 35 | 35 | 33 | 31 | 32 | 29 | 24 | 36 | 35 | 20 | 38 |

As can be seen from Table 1, by simply adding one scratch on the surface of the aluminum laminated film layer of the laser card-making substrate, the aluminum film in the aluminum laminated film layer is divided into two unconnected regions, so that the read and write distance of the obtained contactless IC card can be increased to a certain extent, and the width and the depth of the scratch have little influence on the effect of increasing the read and write distance. When scratches divide the aluminum film into more regions, the obtained contactless IC card has a longer read and write distance, but the area ratio of any two regions is preferably controlled within an appropriate range, as too high area ratio will reduce the technical effect of scratches on improving the read and write distance.

To sum up, according to the present invention, by simply adding at least one continuous scratch on the surface of the aluminum film in the aluminum laminated film layer on the surface of the common card-making substrate, the aluminum film therein is divided into at least two regions which are not connected with each other, which allows the contactless IC card (or electronic tag) made using the card-making substrate to have a longer read and write distance without damaging the appearance effect of the laser aluminum laminated film.

The applicant has stated that the above is only specific embodiments of the present invention, but the scope of the present invention is not limited thereto, and it should be apparent to those skilled in the art that any change or substitution that can be easily conceived by those skilled in the art based on the technology disclosed by the present invention is within the scope of the present invention.

What is claimed is:

1. A card-making substrate which comprises an aluminum laminated film layer (001), a bonding adhesive layer (002) and a base material layer (003) being stacked in sequence;
at least one continuous scratch is formed on an aluminum film surface of the aluminum laminated film layer (001);
the scratch has a depth greater than the thickness of the aluminum film in the aluminum laminated film layer (001), and the aluminum film in the aluminum laminated film layer (001) is divided into at least two regions that are not connected with each other by the scratch and the edge of the aluminum laminated film layer (001).

2. The card-making substrate according to claim 1, wherein the area ratio of any two aluminum film regions in the aluminum laminated film layer (001) is 0.01-100:1.

3. The card-making substrate according to claim 1, wherein the aluminum film in the aluminum laminated film layer (001) is divided into 6-20 regions that are not connected with each other by the scratch and the edge of the aluminum laminated film layer (001).

4. The card-making substrate according to claim 1, wherein the aluminum film in the aluminum laminated film layer (001) is divided into 6-20 triangular, quadrangular or pentagonal regions that are not connected with each other by the scratch and the edge of the aluminum laminated film layer (001).

5. The card-making substrate according to claim 1, wherein the aluminum film in the aluminum laminated film layer (001) is divided into 6-20 triangular, rectangular, square or rhombus regions that are not connected with each other by the scratch and the edge of the aluminum laminated film layer (001).

6. The card-making substrate according to claim 1, wherein the scratch has a width of 0.001-10 mm.

7. The card-making substrate according to claim 1, wherein the depth of the scratch is 101-4000% of the thickness of the aluminum film in the aluminum laminated film layer (001).

8. The card-making substrate according to claim 1, wherein the scratch on the surface of the aluminum laminated film layer (001) is obtained by performing laser etching, chemical etching or mechanical cutting on the aluminum laminated film layer (001).

9. The card-making substrate according to claim 1, wherein the aluminum laminated film layer (001) includes a polymer film laminated with an aluminum film on single side.

10. The card-making substrate according to claim 1, wherein the thickness of the aluminum film in the aluminum laminated film layer (001) is 10-50 nm.

11. The card-making substrate according to claim 1, wherein the bonding adhesive layer (002) has a thickness of 1-50 μm.

12. The card-making substrate according to claim 1, the base material layer (003) has a thickness of 0.1-0.5 mm.

13. A preparation method of the card-making substrate according to claim 1, which comprises the following steps:
Step (1), the aluminum laminated film is coated with a bonding adhesive on the side containing an aluminum film; after the adhesive becomes dried, the side of the aluminum laminated film containing the bonding adhesive is laminated with a substrate layer (003), followed by cutting to obtain a pretreated substrate;
Step (2), laser etching treatment is performed on the surface of the aluminum laminated film layer (001) in the pretreated substrate obtained in Step (1) so as to form continuous scratch(es) on the surface of the aluminum film, so that a card-making substrate is obtained.

14. The preparation method according to claim 13, wherein the base material layer (003) in Step (1) is obtained by roll-coating a backing adhesive on each of the upper and lower surfaces of the base material, followed by drying and cutting.

15. The preparation method according to claim 13, wherein the surface of the aluminum laminated film in Step (1) has a laser effect.

16. A preparation method of the card-making substrate according to claim 1, which comprises the following steps:
Step (a), laser engraving, chemical etching or mechanical cutting treatment is performed on the surface of the aluminum laminated film containing an aluminum film so as to form continuous scratch(es) on the surface of the aluminum film, so that an aluminum laminated film with scratch(es) on the surface is obtained;
Step (b), the aluminum film in the aluminum laminated film with the scratch(es) on the surface is coated with a layer of bonding adhesive; after the adhesive becomes dried, the side of the aluminum laminated film containing the bonding adhesive is laminated with a base material layer (003), thus the card-making substrate is obtained.

17. The preparation method according to claim 16, wherein the base material layer (003) in Step (a) is obtained by roll-coating a backing adhesive on each of the upper and lower surfaces of the base material, followed by drying and cutting.

18. The preparation method according to claim 16, wherein the surface of the aluminum laminated film in Step (a) has a laser effect.

19. An IC card or electronic tag, which comprises one piece of the card-making substrate according to claim 1 and an IC chip and a radio frequency communication circuit which are fixed in the base material layer (003) of the card-making substrate.

20. An IC card or electronic tag, which comprises the card-making substrate according to claim 1 having two substrate layers (003) attached to each other, and an IC chip and a radio frequency communication circuit which are fixed in any of the base material layers (003) of the card-making substrate.
